(19) United States
(12) Patent Application Publication
(10) Pub. No.: US 2024/0326561 A1
(43) Pub. Date: Oct. 3, 2024

(54) ROAD CONSTRUCTION MACHINE WITH SEAT CONSOLE FOR FRESH AIR SUPPLY AND METHOD

(71) Applicant: Joseph Vögele AG, Ludwigshafen/Rhein (DE)

(72) Inventors: Bernhard ERDTMANN, Edingen Neckarhausen (DE); Stefan WEBER, Rödersheim-Gronau (DE); Johannes PONTIUS, Schmelz (DE); Jan RIFFEL, Mannheim (DE); Felix KEMPF, Mannheim (DE)

(73) Assignee: Joseph Vögele AG, Ludwigshafen/Rhein (DE)

(21) Appl. No.: 18/617,811

(22) Filed: Mar. 27, 2024

(30) Foreign Application Priority Data
Mar. 27, 2023 (EP) 23164330.5

(51) Int. Cl. B60H 1/24; B60H 1/00; B60H 3/06

(52) U.S. Cl. CPC B60H 1/246; B60H 1/00407; B60H 3/0608

(57) ABSTRACT

The disclosure relates to a road construction machine, which is available in the form of a road paver or a feeder vehicle for a road paver, comprising a driver's control station for a driver of the road construction machine, wherein the driver's control station has at least one seat console that comprises a fresh air system. Furthermore, the disclosure relates to a method for generating an improved air quality on an openly configured driver's control station of a road construction machine.

### CROSS-REFERENCE TO RELATED APPLICATIONS

### Technical Field

This application claims foreign priority benefits under 35 U.S.C. § 119 (a)-(d) to European patent application number EP 23164330.5, filed Mar. 27, 2023, which is incorporated by reference in its entirety.

The present disclosure relates to a road construction machine with a seat console for fresh air supply and to a method for generating a fresh air flow by means of a seat console of a road construction machine.

### BACKGROUND

So-called ventilation systems are currently used on road pavers, the basic function of which is to extract bitumen and oil-containing vapors above the auger chamber. The extracted vapors are led away from the workplaces by means of a fan and a hose system. Such a ventilation system is disclosed, for example, in DE 10 2012 011 693 A1. However, such an extraction system takes up a lot of space on the road paver and partially prevents the driver from seeing to the rear of the paving screed.

U.S. Pat. No. 6,290,286 B1 discloses an excavator vehicle with a closed driver's cab. Within the closed driver's cab, an air conditioning device is installed behind a driver's seat on a cab floor, from which air supply lines lead to a control panel positioned in front of the driver's seat.

WO 2022/044586 A1 discloses a spectator seat or an aircraft seat with an air barrier device installed on the headrest, which is suitable for supplying fresh air. This is primarily intended to prevent the spread of bacteria and viruses in closed rooms.

EP 3 636 466 A1 discloses an air purification device for attachment to a vehicle seat installed in the vehicle interior.

### SUMMARY

It is an object of the disclosure to improve the air quality for operators on a road construction machine exposed to bitumen-containing vapors during operation by means of simple, constructive means.

This problem is solved by means of a road construction machine according to the disclosure. Furthermore, this problem is solved by means of a method for generating a fresh air flow according to the disclosure.

The disclosure relates to a road construction machine which is available in the form of a road paver or a feeder vehicle for a road paver. The road construction machine according to the disclosure comprises a driver's control station for a driver of the road construction machine, which is configured to be open to at least one side. This driver's control station has at least one seat console which, according to the disclosure, comprises a fresh air system.

Due to the open design of road pavers or feeder vehicles, the driver's control station on such road construction machines is generally well ventilated. Nevertheless, it is possible that bitumen-containing vapors from the hopper or the auger chamber can enter the driver's control station through the open sides of the driver's control station. Known extraction systems used on road pavers attempt to extract the vapors directly at the point where they are generated and blow them out in an area above the workstations, for example above the roof of the driver's control station.

The disclosure deviates from this previous, typical procedure in that the improvement in air quality is achieved directly at the operator's workplace by the fresh air system provided on the seat console. This allows fresh air enrichment to be generated in the immediate vicinity of the operator on the seat console. The operator thus sits directly in a fresh air atmosphere that is open to the outside, through which, however, vapors generated outside can only reach the operator to a very limited extent, if at all. Even vapors rising from the hopper area or the auger chamber into the open driver's control station can thus be neutralized by the fresh air system assigned directly to the operator on the seat console, i.e., i.e., brought to a concentration level that is not critical for the operator.

The fresh air system according to the disclosure thus provides a protective atmosphere of fresh air for the operator in an open working environment by supplying the operator with fresh air from the immediate vicinity, that is, directly at the seat console, in addition to the fresh air supply provided via the open side(s) of the driver's control station. This greatly improves the working conditions for the operator on the seat console. By means of this additional fresh air supply provided on the openly formed driver's control station by means of the fresh air system according to the disclosure, the legally required limit values for air conditions can be reliably complied with on appropriately equipped road pavers or feeder vehicles.

As the fresh air system according to the disclosure is arranged directly on the seat console of the road construction machine, it takes up little space. Thus, the daily routines of the work processes taking place on the road construction machine are not disturbed. The fresh air system installed on the seat console according to the disclosure is easy to operate and inexpensive to manufacture.

A preferred variant provides for the seat console to have a console floor, which is in particular pivotably and/or displaceably mounted, to the underside of which at least one fan unit of the fresh air system is attached. In this position, the fan unit is well protected. Furthermore, little operating noise of the fan unit is perceived by the operator on the seat console from this position, as the console floor functions excellently as a noise barrier in between. Thus, the fresh air system operates quietly even at high speeds of the fan unit. In addition, the fan unit is located on the underside of a pivotably mounted console floor, in the swung-out state of which it is in a position in which it is swung out over the driver's operating platform so that it is easily accessible from below, for example for service work.

One variant provides that the fan unit is actually installed on the seat console, but at a different location, for example behind a (driver's) seat of the seat console, in particular behind a backrest.

A preferred embodiment provides that the fan unit is accommodated within a step created by the console floor. This step provides a sufficiently large mounting space for the fan unit. In addition, other units of the fresh air system can be easily accommodated in it, for example a filter unit provided for this purpose. The units of the fresh air system housed underneath in the step are tidied up in a technically sensible manner, as they do not form a tripping hazard on the console floor.

According to one embodiment of the disclosure, the fan unit is configured for detachable or fixed attachment of a filter unit. By means of a detachable attachment, the filter unit can be removed from the fan unit while the fan unit remains on the seat console. This allows the filter unit to be replaced without any problems.

It would be useful if the fan unit comprised at least one electrically, hydraulically or pneumatically operated fan. An electric fan could, for example, be connected to a power supply line running along the underside of the console floor. A hydraulic or pneumatic fan could, for example, be connected to a hydraulic or pneumatic system routed along the underside of the console floor.

In particular, the fan is a centrifugal fan or an axial fan. As a centrifugal fan, the fan can have a low installation height in particular and can therefore be mounted in a compact manner below the console floor. Moreover, a centrifugal fan is preferred for supplying the seat console with fresh air on both sides.

It would be conceivable that the fan unit provides several fans that can be controlled in parallel, in particular two fans mounted on the underside of the console floor, which convey fresh air in separate fresh air lines. The operation of the respective fans could thereby be controlled independently of each other, for example to generate fresh air in different areas of the seat console, possibly with different intensities. In addition, the use of several fans can ensure low-speed, i.e., i.e., noise-reduced, fan operation and still provide a high supply of fresh air despite the low speed.

According to one embodiment of the disclosure, the fresh air system comprises at least one filter unit arranged on an intake side and/or on an exhaust side of the fan unit. If the filter unit is arranged on the intake side, the fan can be protected from contamination. In this variant, the fan generates a negative pressure and draws in the ambient air cleaned by the filter unit so that filtered fresh air exits from its exhaust side. If the filter unit is arranged on the exhaust side, the fan pushes unfiltered ambient air through the filter unit positioned at its outlet. If a filter unit is arranged on both the intake side and the exhaust side, the filtered air drawn in by the fan unit can be filtered again on the exhaust side.

Preferably, the filter unit is located together with the fan unit underneath the console floor or together with the fan unit at a different location on the seat console, for example behind a seat backrest. The filter unit is particularly well protected under the console floor and is readily accessible from below when the console floor is swung out, making it easy to replace. In addition, if the filter unit and the fan unit are housed underneath the console floor, they do not form a tripping hazard on the console floor, that is, in the area of the operator.

For servicing purposes, it would be particularly useful if the filter unit and the fan unit were separate modules that can be coupled together, that is, not housed in a common housing. This allows the filter unit to be removed from the fan unit without having to dismantle housing parts of the fan unit.

It would be conceivable for the filter unit to be configured as a plug-on module for tool-free attachment to the fan unit. In particular, the filter unit is available as a stable filter arrangement consisting of several filter elements, which does not require a separate filter housing. This reduces the cleaning effort on the construction site. For example, the filter unit could have two filter elements firmly connected to each other, in particular two activated carbon filters glued together, as well as a pre-filter attached to the two filter elements, in particular a foam filter or a fleece filter. These interconnected filter elements, including the pre-filter, can be installed and removed in one piece as a unit.

It would be useful if the fresh air system had at least one nozzle unit that can be arranged both next to a headrest of the seat console and next to a backrest of the seat console. This allows the nozzle unit to be positioned individually by the operator. In particular, the fresh air system comprises a holder that extends at least in sections laterally of the headrest and laterally of the backrest, wherein the nozzle unit can be attached to the holder in various positions in order to be associated with either the headrest or the backrest. Alternatively, the nozzle unit could also be installed in a fixed position.

According to one embodiment, the fresh air system comprises at least one further nozzle unit for fresh air, which can be arranged in various positions on the side of a seat base of the seat console. This allows the nozzle unit to be positioned further forward or further rearward when the seat base is adjusted longitudinally. Alternatively, the additional nozzle unit could also be installed in a fixed position.

The positions of the nozzle units can be fixed in particular by screwing them on and off, by moving them and/or by using magnetic holders.

It would be conceivable for the nozzle unit and the other nozzle unit to be operated together or individually to supply fresh air. For this purpose, the fresh air system can be equipped with a valve unit.

One variant provides that the fresh air system has the nozzle units described in the previous two paragraphs on both sides of the seat console. This allows the operator to be supplied with fresh air on both sides of the seat console.

One variant provides that the nozzle unit, i.e., i.e., at least one of the nozzle units described above, has at least one fresh air opening with adjustable lamellae. This allows the direction of the fresh air flow to be determined. The direction of the fresh air flow can thus be set specifically by the operator.

According to one embodiment of the disclosure, the nozzle unit, i.e., at least one of the nozzle units described above, has both at least one fresh air opening for an outlet flow of fresh air, for example a round air opening, and at least one nozzle for a desired other outlet flow, for example a flat nozzle or fan nozzle, for forming an air barrier. It would be conceivable to use a fan unit to form the outlet flow for fresh air and a separate fan unit to form the air barrier. The two fan units can be controlled independently of each other at different speeds. This also allows different flow velocities to be set at different points on the seat console.

In particular, the nozzle for forming the air barrier can be set such that the fresh air atmosphere can be kept in the area of the operator for a longer period of time. The air barrier could, for example, be formed outside the fresh air outlet flow facing the operator, so that the fresh air outlet flow formed near the operator does not spread outwards, but is concentrated in the area of the operator. The air barrier is thus present as an auxiliary flow for the preferred maintenance of the fresh air atmosphere in the area of the operator. The fresh air flow from the seat console and/or a fresh air flow from the control panel can be introduced into the air barrier such that it specifically enriches the atmosphere with fresh air in the area of the operator. In addition, the air barrier formed at the seat console can be used to shield the operator from bitumen-containing vapors entering the driver's control station from the outside.

Preferably, at least one, in particular several, air ducts or fresh air lines lead away from the fan unit in order to supply at least one nozzle unit with fresh air. For example, two air ducts or fresh air lines could lead away from a radial fan in a radial direction, in particular opposite the radial fan, in order to supply nozzle units on both sides of the seat console with fresh air. In this case, the fan unit can be used as a central fresh air supplier for several nozzle units positioned on both sides of the seat console.

In particular, the nozzle unit is arranged to be adjustable, for example pivotable. For example, a nozzle unit mounted next to the headrest can be pivoted downwards or upwards, depending on how far the headrest is retracted or extended on the backrest, in order to effectively supply the operator in the seat with fresh air.

According to a preferred variant, the fresh air system provided on the seat console can be used together with another fresh air system arranged on a control panel of the driver's control station. In particular, the two fresh air systems can complement each other such that together they provide a larger area on the driver's control station with a desired fresh air atmosphere, in particular ensuring an increased supply of fresh air in the area of the operator or driver. In particular, the two fresh air systems can be adjusted to each other such that the operator remains within a fresh air zone created on the driver's control station by means of the other fresh air system even when leaving the fresh air zone provided by the fresh air system formed on the seat console.

It would be conceivable for the two fresh air systems to be configured to generate opposing, converging fresh air flows, which are in particular surrounded at least in some areas by the air barrier formed by the nozzle unit on the headrest. This leads to a fresh air turbulence effect in the area of the operator, whereby the fresh air atmosphere can be maintained for a longer period in the area of the operator. In addition, this allows the respective velocities of the converging fresh air flows to be reduced, which is particularly pleasant in the immediate vicinity of the operator, especially at the operator's head height. To achieve this effect, it would be conceivable to set the fresh air flows to converge at a predetermined height in front of the operator.

One variant provides that the fresh air system of the seat console and/or the fresh air system of the control panel is configured to control the temperature of the fresh air flow. On the one hand, this allows a fresh air atmosphere with a desired temperature to be generated for the operator or driver. On the other hand, depending on the temperature differences of the fresh air flows, thermal flow effects can be used to specifically generate a fresh air enrichment in the area of the operator or driver.

It would be possible for the seat console to be a pivotable, rotatable and/or transversely displaceable driver's seat console mounted on the driver's control station, wherein the fresh air system provided on it can follow these movements.

It would be conceivable to vary the fresh air flow rate flowing out of the fresh air system by adjusting the speed of the fan unit. This makes it possible, for example, to increase the fresh air supply if the road construction machine generates a particularly high amount of vapor, for example during a material transfer process of paving material into a hopper of the road construction machine. Such a speed adjustment can take place automatically or be set manually.

It would be conceivable that at least one control element for adjusting the speed of the fan unit is provided directly on the seat console, in particular directly on the fresh air system, on a control panel of the driver's control station and/or on an external control station of the road construction machine formed separately from the driver's control station. In the latter variant, a screed operator on the road paver could increase the fresh air supply for his colleague on the driver's control station accordingly if he notices that a high level of vapor is being generated during paving.

The control element could, for example, be in the form of a rotary control. One variant provides for a touch display to be provided as a control element, in particular a touch display provided on the control panel of the driver's control station.

Preferably, the fresh air system is available as a hang-on system for the seat console so that it can be easily fitted to existing seat consoles as a retrofit kit. One variant provides that the fresh air system is integrated into the seat console, resulting in a particularly compact structure. With a hang-on system in particular, it would be conceivable for the control element, for example a rotary control, to be formed directly on the fan unit.

One variant provides that the seat console can be mounted on both sides of the driver's control station. It would be conceivable for the seat console to be installed in duplicate on the driver's control station. A preferred variant provides that a sensor system is installed on the driver's control station in order to detect on which of the two seat consoles an operator or driver is located. Based on the measured values from the sensor system, the fresh air system of the occupied seat console could be automatically activated or the fresh air system of the unoccupied seat console could be automatically deactivated. Thus, it is possible to react automatically to a change of seat.

The disclosure further relates to a method for generating a fresh air flow by means of a seat console of a driver's control station, which is configured to be open to the side, of a road construction machine, which is available as a road paver or as a feeder vehicle for a road paver. The driver's control station, which is configured to be open to the side, already ensures that the area on the driver's control station is ventilated with ambient air and can therefore also be supplied with filtered fresh air by means of the seat console. This allows the fresh air atmosphere of the driver's control station of a road paver or a feeder vehicle, which is already ventilated with ambient air via the sides, to be additionally improved by the fresh air supply via the seat console in the immediate vicinity of the operator or driver positioned on the seat console. This means that in the disclosure, the ventilated atmosphere generated by the open structure of the driver's control station in the area of the operator is specifically improved in terms of air quality by the seat console, that is, a fresh air system formed on it.

Preferably, ambient air is drawn in and filtered below a preferably pivotably mounted console floor of the seat console in order to be transported as fresh air to several nozzle units arranged around a seat of the seat console. The intake and filtering of ambient air below the console floor ensures low-noise operation of the fresh air system and also offers a compact structure.

It would be conceivable for the fresh air system to generate fresh air flows both laterally of a headrest and laterally of a seat base of the (driver's) seat, in particular on both sides of the seat console, so that an operator or driver sitting on the seat console can be supplied with fresh air from several directions.

One embodiment provides that the fresh air system provided on the seat console is used to generate at least one fresh air flow at a first velocity and a (fresh) air flow at a second velocity that is greater than the first velocity. In particular, the (fresh) air flow at the second velocity can be generated in the form of an air barrier. It would be conceivable for the air barrier to be generated in the form of an air tunnel that surrounds the fresh air flow, at least in some areas.

It would be conceivable for a fresh air system arranged on the seat console to generate fresh air to interact with another fresh air system used to supply fresh air to the driver's control station in order to increase fresh air enrichment in the area of the seat console. It would be conceivable for the fresh air system of the seat console to be operated together with a fresh air system arranged on the control panel of the driver's control station in order to generate opposing, converging fresh air flows that lead to favorable turbulence effects, whereby a fresh air atmosphere can be maintained in the area of the operator for a longer period of time.

In particular, a fresh air flow rate of the fresh air system provided on the seat console can be regulated by adjusting the speed of the fan unit. It would be conceivable that the speed of the fan unit can be set using a control element that is provided directly on the seat console, in particular directly on the fresh air system, on a control panel of the driver's control station and/or on a control station outside the road construction machine that is separate from the driver's control station.

### BRIEF DESCRIPTION OF THE DRAWINGS

The present disclosure is explained in more detail with reference to the following Figures:

FIG. 1 shows a road construction machine in the form of a road paver;

FIG. 2 shows a road construction machine in the form of a feeder vehicle for a road paver;

FIG. 3 shows a front view of a seat console with fresh air system;

FIG. 4 shows a side view of the seat console with fresh air system from FIG. 3;

FIG. 5 shows a perspective view of the seat console with fresh air system from FIGS. 3 and 4;

FIG. 6 shows a front view of the fresh air system in isolated illustration;

FIG. 7 shows a sectional view of the fresh air system from FIG. 6;

FIG. 8 shows a perspective view of the fresh air system from FIG. 6;

FIG. 9 shows a further perspective view of the fresh air system from FIG. 6;

FIG. 10 shows a seat console with a fresh air system for generating fresh air and an air barrier; and

FIG. 11 shows separate fresh air systems for generating converging fresh air flows.

Identical technical components are provided with the same reference signs throughout the Figures.

### DETAILED DESCRIPTION

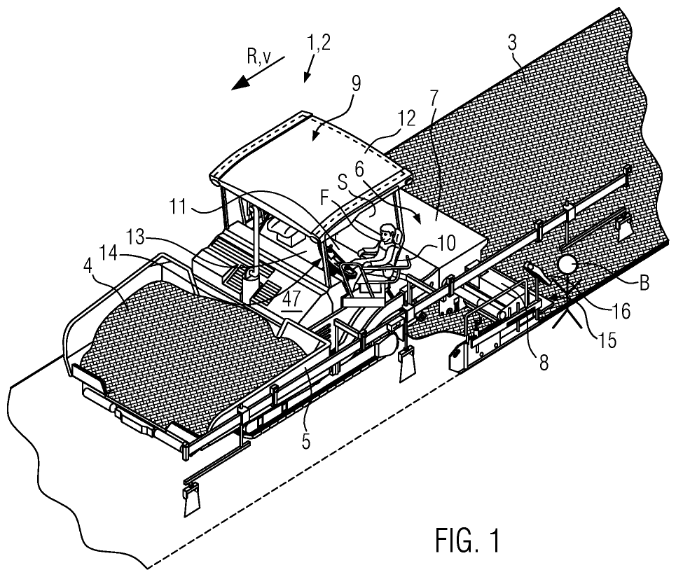

FIG. 1 shows a road construction machine 1 configured as a road paver 2 for producing a new paving layer 3. The road paver 2 produces the new paving layer 3 in the direction of travel R at a paving velocity v. For this purpose, the road paver 2 uses paving material 4, which is stored in a hopper 5 formed at the front of the paver. From the hopper 5, the paving material 4 stored therein is transported by means of a longitudinal conveyor, not shown, against the direction of travel R to a paving screed 6, which is configured to compact the paving material 4 presented to it to form the new paving layer 3.

The paving screed 6 shown in FIG. 1 is configured as an extending screed. The paving screed 6 has a base screed 7 and lateral extending parts 8 for setting the desired paving width of the new paving layer 3.

The road paver 2 of FIG. 1 comprises a driver's control station 9 for a driver F. FIG. 1 shows that the driver's control station 9 is open to the side S and to the rear, that is, the atmospheric conditions, i.e., the air quality, in the vicinity of the driver's control station 9 are essentially present without any countermeasures being taken.

In FIG. 1, the driver F is seated on a pivotably configured seat console 10, by means of which he is swung out over a driver's operating platform 11 and positioned laterally of the driver's control station 9, so that he has a good view of the area next to the road paver 2. However, in this position swung out over the driver's operating platform 11, the driver F no longer sits behind a windshield 13 provided on the roof structure 12, so that he is more exposed to vapors and/or aerosols coming from the hopper 5 as well as vapors and/or aerosols from the area of the paving screed 6.

On the driver's control station 9 of the road paver 2, a control panel 14 is provided for the driver F. The control panel 14 is configured for controlling and monitoring processes that can be carried out by the road paver 2. For example, the driver F can set the velocity v of the road paver 2 in the direction of travel R on the control panel 14.

Furthermore, FIG. 1 shows an external control station 15, which provides a workplace for a screed operator B on the outside of the paving screed 6 in order to control and monitor processes of the road paver 2, in particular the paving screed 6. For this purpose, a further control panel 16 is provided at the external control station 15.

The driver's and external control stations 9, 15 on the road paver 2 in FIG. 1, which are open to the surroundings, are generally well ventilated due to their open configuration, but are also reached by the vapors and/or aerosols generated during paving.

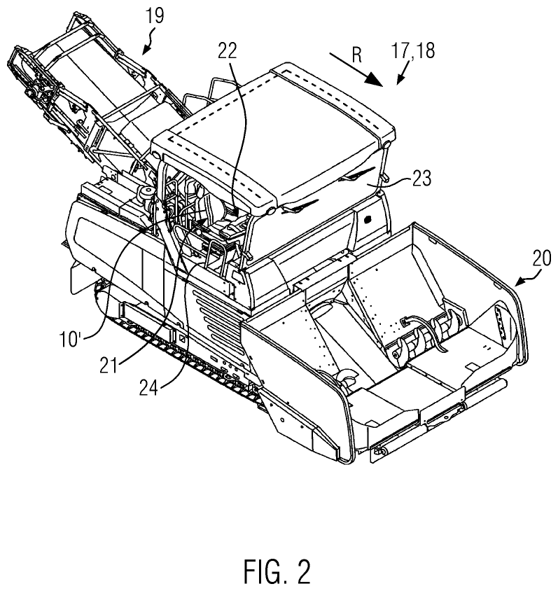

FIG. 2 shows another road construction machine 17 configured in the form of a feeder vehicle 18 for a road paver 2. Such a feeder vehicle 18 is used in practice to supply a road paver 2 as shown in FIG. 1 with paving material 4. For this purpose, the feeder vehicle 18 travels in front of the road paver 2 in the direction of travel R and throws paving material 4 into the hopper 5 of the road paver 2 traveling behind it by means of a conveyor device 19 formed on the feeder vehicle 18.

The feeder vehicle 18 in FIG. 2 has a hopper 20 for accommodating paving material 4. The conveyor 19 extends as far as the hopper 20 and can thus transport the paving material 4 stored therein out of the same, against the direction of travel R in the direction of the following road paver 2 and transfer it to the latter.

According to FIG. 2, the feeder vehicle 18 has a driver's control station 21. This driver's control station 21 is also open to the sides and to the rear, so that vapors and/or aerosols can reach the driver F via the open sides of the driver's control station 21 and from behind. A seat console 10′ for the driver F and a control panel 22 for controlling and monitoring the processes carried out by the feeder vehicle 18 are mounted on the driver's control station 21. In FIG. 2, the control panel 22 is positioned behind a windshield 23 of the feeder vehicle 18, however, together with the seat console 10′, it can be brought into a position next to the driver's control station 21, that is, it can be pivoted beyond its driver's operating platform.

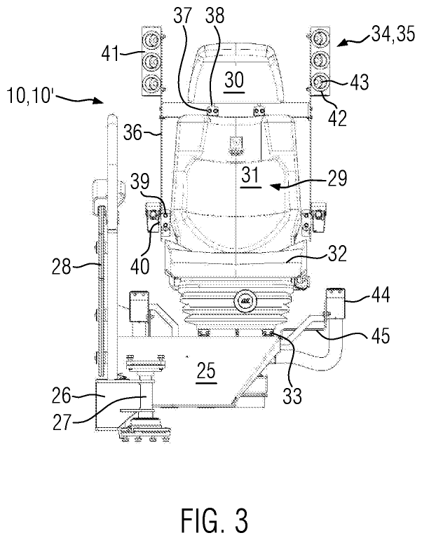

FIG. 3 shows an isolated view of the seat console 10, 10′. The seat console 10, 10′ has a console floor 25, which is pivotably mounted on the driver's control station 9, 21. The console floor 25 is mounted on a pivot arm 26, the front end of which is coupled to a pivot bearing 27. An anti-fall guard 28 is mounted on the pivot arm 26.

The seat console 10, 10′ in FIG. 3 further comprises a (driver's) seat 29 mounted on the console floor 25. The seat 29 has a headrest 30, a backrest 31 and a seat base 32. The seat base 32 in FIG. 3 is attached to the console floor 25 by means of a rail device 33 and can thus be moved into various positions on the console floor 25.

A fresh air system 34 is provided on the seat console 10, 10′ shown in FIG. 3. The fresh air system 34 shown in FIG. 3 is configured as a hang-on system 35 for detachable attachment to the seat 29. The fresh air system 34 has a holder 36 with fastening units 37 for detachable attachment to headrest bars 38 and with fastening units 39 for detachable attachment to seat back holders 40. Two nozzle units 41 are fastened to the holder 36. The two nozzle units 41 are positioned on both sides of the headrest 30. The nozzle units 41 each have three fresh air openings 42 with adjustable lamellae 43.

Furthermore, FIG. 3 shows that the fresh air system 34 also has further nozzle units 44 on both sides of the seat base 32. These further nozzle units 44 are each supported on the console floor 25 by means of further holders 45.

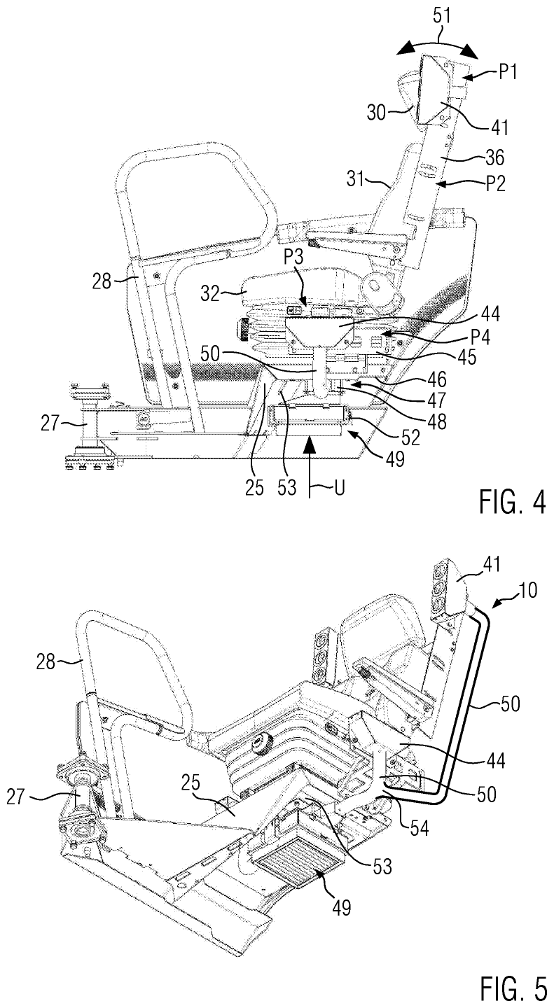

FIG. 4 shows a side view of the seat console 10 from FIG. 3. A fan unit 47 is attached to an underside 46 of the console floor 25. The fan unit 47 has a fan 48, which is configured as a radial fan in FIG. 4. A filter unit 49 is arranged below the fan 48. The filter unit 49 is connected to the intake side of the fan 48. Ambient air U can be drawn in through the filter unit 49 by the fan 48, wherein the fresh air filtered thereby is conveyed from the fan 48 via air ducts 50 to the respective nozzle units 41, 44.

FIG. 4 also shows that the nozzle unit 41 positioned laterally of the headrest 30 is pivotably mounted on the holder 36. This is shown schematically by the double arrow 51. In FIG. 4, the nozzle unit 41 is attached to the holder 36 at an upper position P1 in order to be mounted laterally of the headrest 30. According to FIG. 4, the nozzle unit 41 can also be attached to the holder 36 at a lower position P2 in order to be positioned laterally of the backrest 31.

Furthermore, FIG. 4 shows that the nozzle unit 44 positioned laterally of the seat base 32 is mounted on the holder 45 in a front position P3. The nozzle unit 44 can also be attached to the holder 45 at a rear position P4. This allows the nozzle unit 44 to be positioned accordingly, depending on the position in which the seat 29 is adjusted by means of the rail arrangement 33.

The positioning options of the nozzle units 41, 44 shown in FIG. 4 described with regard to positions P1, P2, P3, P4 are also provided in a comparable manner on the other side of the seat console 10, 10′.

A quick release 52 is provided for the filter unit 49 for detachable attachment to the fan unit 47. It would also be possible for the filter unit 49 to be plugged onto an intake opening of the fan unit 47 simply by positive and/or non-positive engagement.

FIG. 4 shows that both the fan unit 47 and the filter unit 49 attached to it are accommodated within a step 53 created by the console floor 25. The fan unit 47 and the filter unit 49 are thus well protected and are easily accessible, particularly from below, when the seat console 10, 10′ is positioned in the swung-out state as shown in FIG. 1.

FIG. 5 shows a perspective view of the seat console 10. The nozzle units 41, 44 are supplied with filtered fresh air by the fan unit 47 via the air ducts 50. The air ducts 50 are connected to each other via a Y-piece 54.

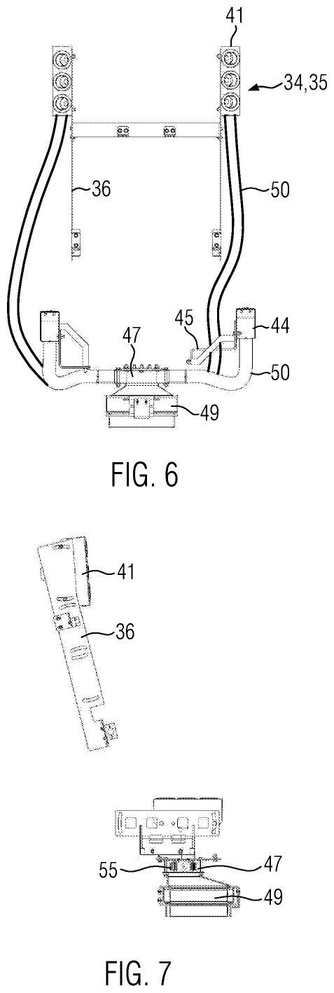

FIG. 6 shows the fresh air system 34 in isolated view. The fresh air system 34 shown in FIG. 6 is available as a hang-on system 35 and can be easily retrofitted to existing seat consoles 10, 10′.

FIG. 7 shows a sectional view of the fresh air system 34 from FIG. 6, in particular a vertical section through the fan unit 47. The fan unit 47 has a radial fan 55.

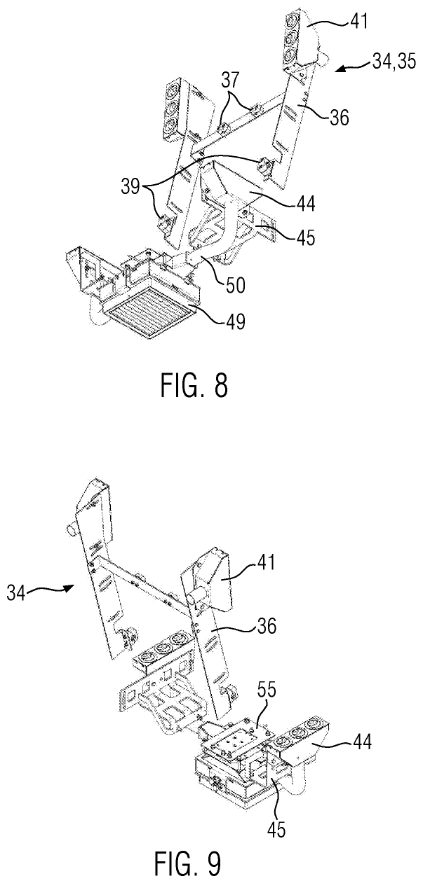

FIG. 8 shows a perspective view of the fresh air system 34. In particular, FIG. 8 shows the fastening means 37 for attaching the holder 36 to the headrest bars 38 and also the fastening means 39 for detachable attachment to the seat back holders 40.

FIG. 9 shows a further perspective view of the fresh air system 34 configured as a hang-on system 35. In particular, FIG. 9 shows a mounting plate 55 for detachably attaching the fan unit 47 to the underside 46 of the console floor 25.

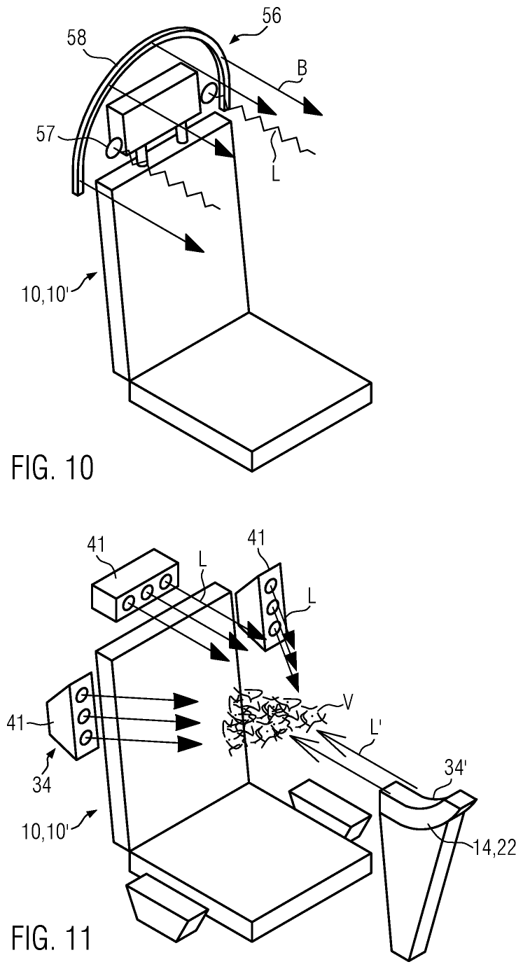

FIG. 10 shows a schematic view of the seat console 10, 10′ with a nozzle unit 56, which is configured to generate both a fresh air flow L and an air barrier B. The fresh air flow L is thereby enclosed by the air barrier B, so that the fresh air flow L can be kept in the area of the person sitting on the seat console 10, 10′ for a longer period of time. The air barrier B also has the purpose of shielding vapors and/or aerosols rising from the outside so that the operator sits reliably in a fresh air atmosphere on the seat console 10, 10′.

To generate the fresh air flow L, the nozzle unit 56 has two fresh air openings 57 as shown in FIG. 10. Furthermore, the nozzle unit 56 has a curved nozzle 58 to form an air barrier B in the form of a tunnel in which the fresh air flow L is enclosed.

FIG. 11 shows the seat console 10, 10′ with nozzle units 41 arranged thereon, the fresh air flows L of which converge with an oncoming fresh air flow L′ from the control panel 14, 22. The converging fresh air flows L, L′ ensure a turbulence V of fresh air in an area directly in front of an operator or driver F positioned on the seat console 10, 10′, so that the fresh air atmosphere can be maintained for a longer period in his vicinity.

What is claimed is:

1. A road construction machine configured as a road paver or a feeder vehicle for a road paver, comprising a driver's control station, which is open at least to one side, for a driver of the road construction machine, wherein the driver's control station has a seat console that comprises a fresh air system.

2. The road construction machine according to claim 1, wherein the seat console comprises a console floor, and the fresh air system comprises a fan unit fastened to an underside of the console floor.

3. The road construction machine according to claim 2, wherein the fan unit is configured for detachable or fixed attachment of a filter unit.

4. The road construction machine according to claim 2, wherein the fan unit comprises an electrically, hydraulically or pneumatically operated fan.

5. The road construction machine according to claim 4, wherein the fan comprises a radial fan or an axial fan.

6. The road construction machine according to claim 2, wherein the fan unit comprises a plurality of fans which can be controlled in parallel.

7. The road construction machine according to claim 2, wherein the fresh air system comprises a filter unit arranged on an intake side and/or on an exhaust side of the fan unit.

8. The road construction machine according to claim 7, wherein the filter unit is positioned together with the fan unit below the console floor and/or the filter unit and the fan unit form separate modules which can be coupled to one another.

9. The road construction machine according to claim 2, wherein the fresh air system comprises at least one nozzle unit for fresh air, which can be arranged both next to a headrest of the seat console and next to a backrest of the seat console.

10. The road construction machine according to claim 2, wherein the fresh air system comprises at least one nozzle unit for fresh air, which can be arranged in different positions laterally of a seat base of the seat console.

11. The road construction machine according to claim 9, wherein the at least one nozzle unit comprises at least one fresh air opening with an adjustable lamella.

12. The road construction machine according to claim 9, wherein the at least one nozzle unit has both at least one fresh air opening for fresh air and at least one nozzle for forming an air barrier.

13. The road construction machine according to claim 9, wherein the fresh air system comprises at least one air duct that leads away from the fan unit in order to supply the at least one nozzle unit with fresh air.

14. The road construction machine according to claim 9, wherein the at least one nozzle unit is arranged adjustably.

15. The road construction machine according to claim 1, further comprising a further fresh air system arranged on a control panel of the driver's control station, and wherein the fresh air system of the seat console is usable with the further fresh air system.

16. The road construction machine according to claim 15, wherein the two fresh air systems are configured to generate oppositely directed fresh air flows which converge and are surroundable at least in some areas by an air barrier.

17. The road construction machine according to claim 2, wherein a speed of the fan unit is adjustable in order to vary a fresh air flow rate flowing out of the fresh air system.

18. The road construction machine according to claim 2, further comprising at least one control element provided for adjusting speed of the fan unit, wherein the at least one control element is provided on the seat console, on a control panel of the driver's control station and/or on an external control station of the road construction machine formed separately from the driver's control station.

19. The road construction machine according to claim 1, wherein the fresh air system is available as a hang-on system for the seat console or is integrated in the seat console.

20. A method for generating a fresh air flow for a driver's control station, which is open to a side, of a road construction machine configured as a road paver or a feeder vehicle for a road paver, the method comprising generating the fresh air flow by a fresh air system of a seat console of the driver's control station.
